(19) United States
(12) Patent Application Publication
(10) Pub. No.: US 2025/0041657 A1
(43) Pub. Date: Feb. 6, 2025

(54) CUSTOMISABLE EXERCISE MAT SYSTEM

(71) Applicant: LIFORME LIMITED, London (GB)

(72) Inventor: James ARMITAGE, London (GB)

(21) Appl. No.: 18/709,389

(22) PCT Filed: Nov. 10, 2022
(86) PCT No.: PCT/GB2022/052860

§ 371 Date: May 10, 2024

(30) Foreign Application Priority Data
Nov. 11, 2021 (GB) 2116262.3

(51) Int. Cl. A63B 21/00; G06Q 30/0601

(52) U.S. Cl. CPC A63B 21/4037; G06Q 30/0621

(57) ABSTRACT

A customisable exercise mat system for producing an exercise mat with surface markings customised based on individual customer selections. A customer input module receives customer selections. An output generator generates mat image data based on the customer's selections. A printer is provided for printing the surface markings onto a mat precursor based on the mat image data for producing the customised exercise mat.

The present invention concerns a customisable exercise mat system, and a method of producing customisable exercise mats. The present disclosure is particularly relevant to customisable yoga mats.

Exercise mats are commonly used by individuals to perform a wide variety of exercises as they provide a softer and cleaner surface upon which to work out. A wide variety of exercises can be conducted on such mats, from press-ups and sit-ups, to stretches and yoga poses. However, a problem with conducting such exercises is that it is not easy for an individual to determine if they are properly aligned on the mat. This is a particular issue for yoga mats.

In this connection, maintaining correct posture and physical alignment during an exercise is extremely important. Misalignment can reduce the effectiveness of a particular exercise and, at worse, cause strains or more serious physical injury. Accordingly, there is a desire for exercise mats which help an individual to ensure correct alignment during exercises.

The applicant has been the pioneer of exercise and yoga mats which include alignment and indicator features to aid users in alignment. However, a particular issue remains in that there is a balance between assisting a user and confusing them with too many markings and/or finding the right combination of markings to aid alignment for their particular body and/or style or level of yoga practice. For example, a more advanced yoga practitioner may require less markings or may only need alignment assistance for specific poses that they find challenging.

The present invention seeks to address the above issues by allowing a customer to obtain a customised exercise mat based on their personal preferences and, in particular, to allow a customer to select and customise alignment guides on a mat for use in yoga.

According to a first aspect of the invention, there is provided a customisable exercise mat system for producing an exercise mat with surface markings customised based on individual customer selections, the system comprising: a customer input module for receiving customer selections; an output generator for generating mat image data based on the customer's selections; and a printer for printing the surface markings onto a mat precursor based on the mat image data for producing the customised exercise mat.

In embodiments, the exercise mat is a yoga mat and one or more of the surface markings are used for user alignment during yoga poses.

In embodiments, the customer input module for receiving customer selections comprises a user interface for receiving selections from a plurality of option categories.

In embodiments, the plurality of option categories include at least one of: surface colour, theme, indicator design, and indicator colours, 45 degree alignment guides, end to end line alignment guides, reverse points alignment guides, topper features, and customer name, monogram or the customer's chosen slogan or written message.

In embodiments, the surface markings comprise a plurality of customisable zones and the customer selections designate colours to be applied to those customisable zones in the generated mat image data.

In embodiments, each of the plurality of customisable zones includes one or more predefined modular component alignment guides, and wherein the customer selections designate the precise combination of the modular component alignment guides and/or the colours to be applied to those alignment guides.

The configurator also allows the customer to select the thickness/visual prominence of the alignment markers, ranging from 3 lines to 7 lines which roughly doubles the thickness of the individual components of the alignment guides and the overall design. As such, it gives customisabilty to personal choice of the degree of prominence of the visual and tactile markers.

In embodiments, the plurality of customisable zones and the modular component alignment guides to be fit within those zones correspond to vector elements in the mat image data.

In embodiments, the customer selections designate colours to be applied by applying a color code to the vector elements.

In embodiments, the printer comprises a latex ink printer for printing latex ink onto the surface of a mat precursor. In other embodiments, different ink types and bases may be used.

In embodiments, the printer comprises a mat precursor selector for selecting a mat precursor from a plurality of mat precursor types based on the mat image data.

In embodiments, the printer further comprises a roller flatbed and a vacuum for holding the mat precursor in place.

In embodiments, the printer is configured to deposit an ink base layer over regions of the mat precursor surface designated to be printed on by surface markings based on the received mat image data, before printing the surface markings.

In embodiments, the printer is configured to heat-fuse the ink onto the mat material.

In embodiments, the printer further comprises a curing element for curing the mat once the ink has been deposited on its surface.

According to a second aspect of the invention, there is provided a method of producing a customisable exercise mat with surface markings customised based on individual customer selections, the method comprising: receiving customer selections via a customer input module; generating mat image data based on the customer's selections at an output generator; and printing the surface markings onto a mat precursor based on the mat image data using a printer.

Illustrative embodiments of the present invention will now be described with reference to the accompanying drawings in which:

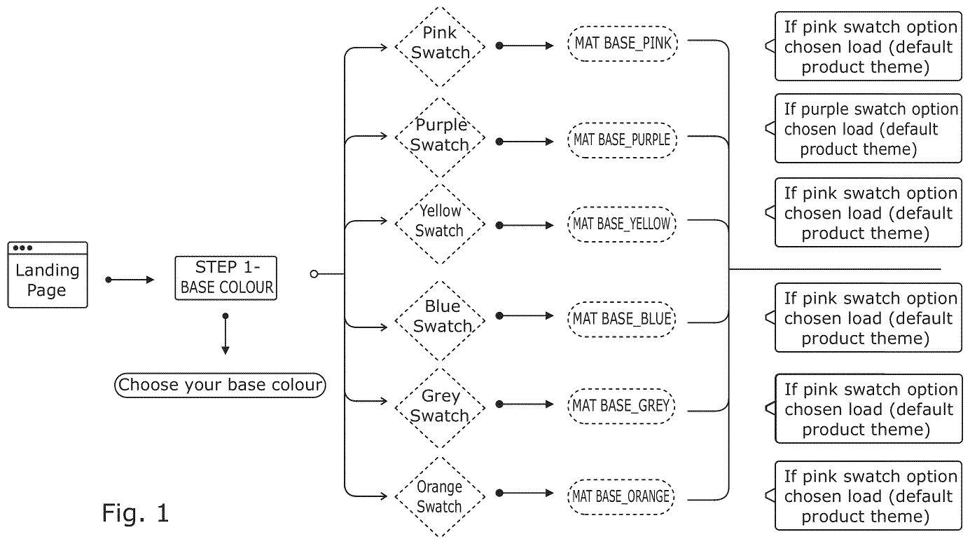

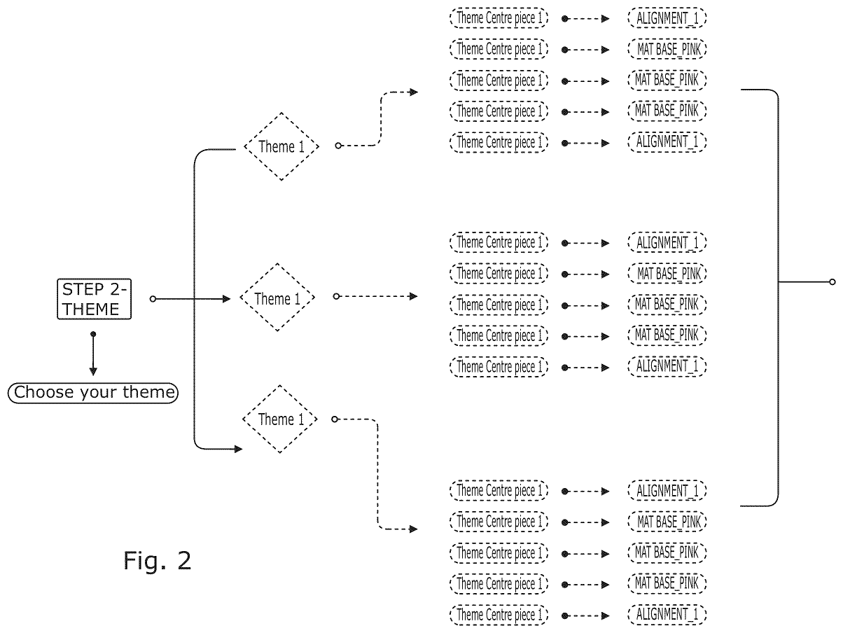

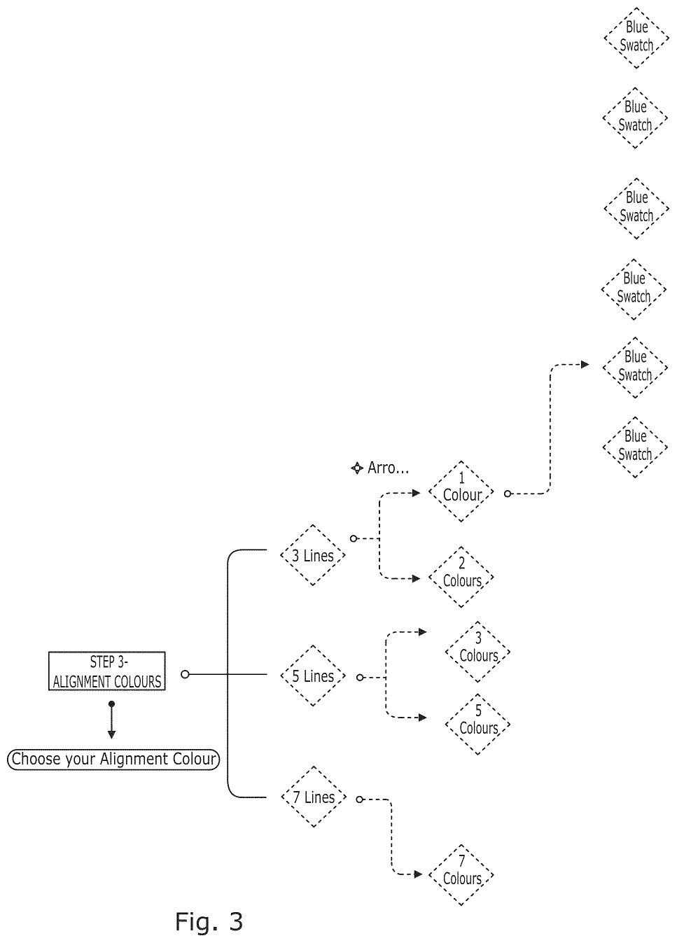

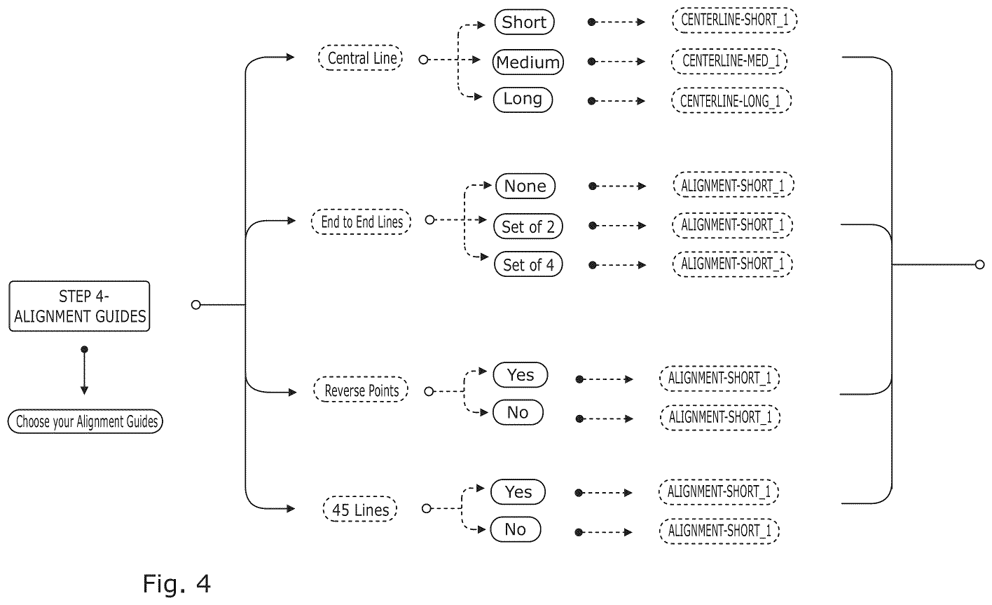

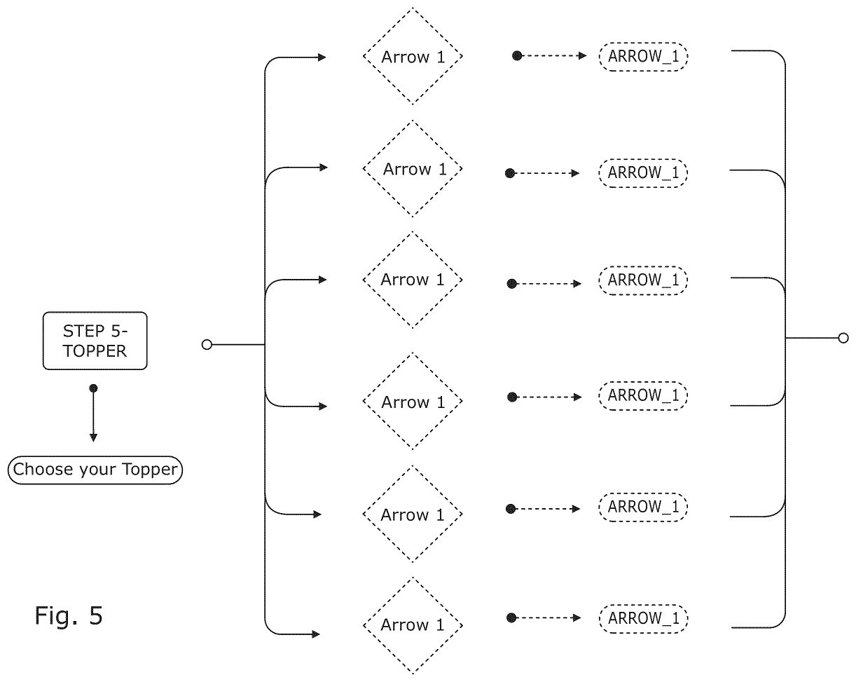

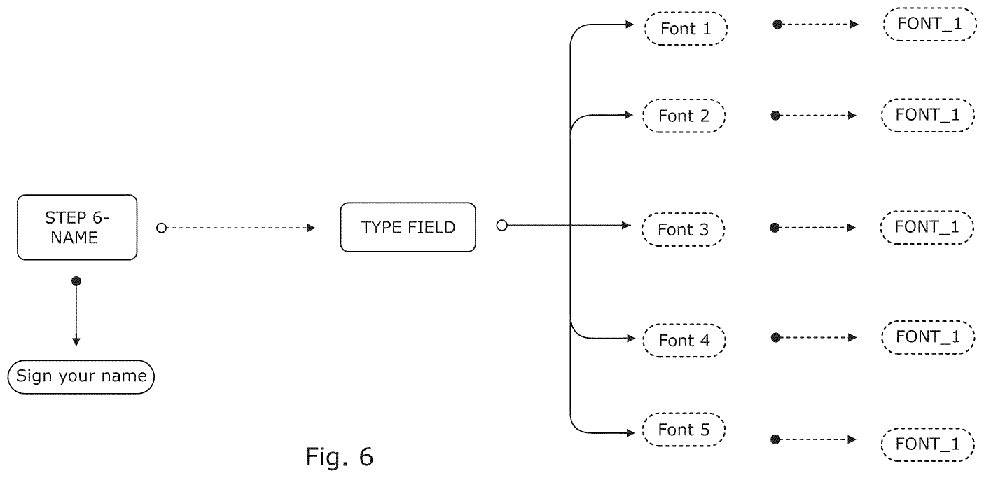

FIGS. 1 to 6 show a sequence of flow chart logic diagrams showing the selection steps available in the yoga mat customiser for allowing a customer to select customisation options for a yoga mat; and

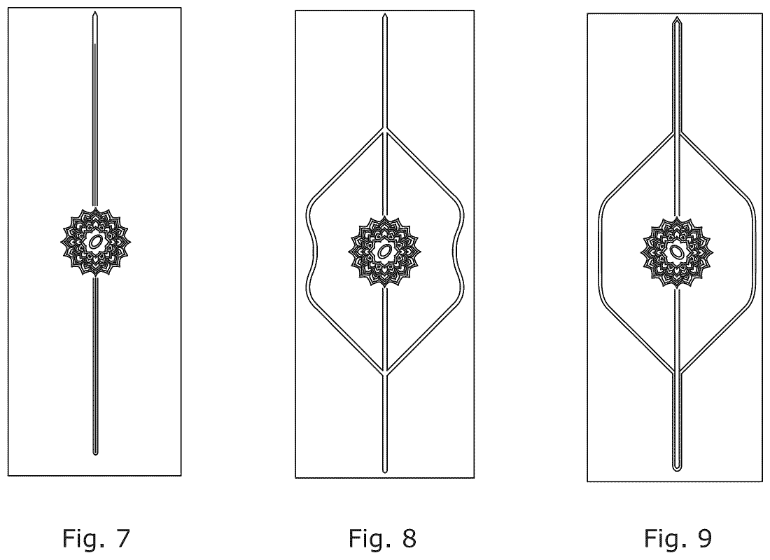

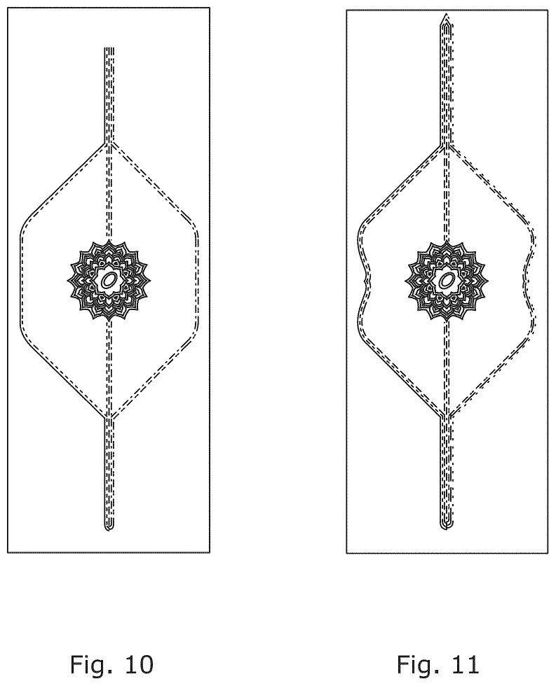

FIGS. 7 to 11 show different illustrative yoga mat customisation options.

According to an embodiment of the invention, a system for producing customisable yoga mats is provided. A customer accesses the system through a user interface, such as a website page, on which they make their selections. The selections are then communicated to a printer to produce the mat.

FIGS. 1 to 6 show the selection steps available via the user interface to the customiser. This allows the customer to select customisation options for their yoga mat. This includes allowing the customer to choose:
1. Surface Colour
2. Theme
3. Line Design & Colours—This is where the colour logic and changing vector elements comes in. (5 options of line thickness/prominence+many colours)
4. Alignment Guides—45 degree lines (3 options)
5. Alignment Guides—End to End Lines (3 options)
6. Alignment Guides—Reverse Points (3 options)
7. Top it off (3 options)
8. Add a name or slogan (multiple options)

It will be understood that other options may also be included.

The user's selection of Line Design & Colours (3) above determines the chosen alignment guide which determines the other vector elements such as the end to end lines and themes.

Multiple colour palettes are available. As shown in the flow chart, the available colours are coded, Eg. C6, C1, C4. By doing this, the same vector elements are used, and the colour codes are simply replaced to create different design options. As such, an automated process may be provided.

### Manufacturing Process

Once the customer confirms their selections, an order file and image file is sent to the printer, for example by File Transfer Protocol (FTP). As such, the printer may be located at a remote site.

The printer picks a base or mat precursor according to the user's selection, and loads the image file in the ink printer software. The precursor mat is laid on to roller flatbed and a smart vacuum is used to hold the precursor mat in place.

The printer then prints the selected image file using latex printing technology. This latex printing involves using print heads to effectively distribute water-based inks onto the mat precursor. During the latex printing process, the ink is heat-fused onto the mat material, rather than using solvents which plasticise during curing. This thereby increases waterproofing properties and durability/scratch resistance.

Once printing has finished, the mat is fed through a curing element.

Upon completion, the mat is finished using a step by step packing guide. The finished mat may then be dispatched to the customer.

It will be understood that the embodiment illustrated above show applications of the invention only for the purposes of illustration. In practice the invention may be applied to many different configurations, the detailed embodiments being straightforward for those skilled in the art to implement.

1. A customisable exercise mat system for producing an exercise mat with surface markings customised based on individual customer selections, the system comprising:
a customer input module for receiving customer selections;
an output generator for generating mat image data based on the customer's selections; and
a printer for printing the surface markings onto a mat precursor based on the mat image data for producing the customised exercise mat.

2. A customisable exercise mat system according to claim 1, wherein the exercise mat is a yoga mat and one or more of the surface markings are used for user alignment during yoga poses.

3. A customisable exercise mat system according to claim 1, wherein the customer input module for receiving customer selections comprises a user interface for receiving selections from a plurality of option categories.

4. A customisable exercise mat system according to claim 3, wherein the plurality of option categories include at least one of: surface colour, theme, indicator design, and indicator colours, 45 degree alignment guides, end to end line alignment guides, reverse points alignment guides, topper features, and customer name, monogram or slogan.

5. A customisable exercise mat system according to claim 1, wherein the surface markings comprise a plurality of customisable zones and the customer selections designate colours to be applied to those customisable zones in the generated mat image data.

6. A customisable exercise mat system according to claim 5, wherein each of the plurality of customisable zones includes one or more predefined modular component alignment guides, and wherein the customer selections designate the precise combination of the modular component alignment guides and/or the colours to be applied to those alignment guides.

7. A customisable exercise mat system according to claim 5, wherein the plurality of customisable zones and the modular component alignment guides to be fit within those zones correspond to vector elements in the mat image data.

8. A customisable exercise mat system according to claim 7, wherein the customer selections designate colours to be applied by applying a colour code to the vector elements.

9. A customisable exercise mat system according to claim 1, wherein the printer comprises a latex printer for printing latex ink onto the surface of a mat precursor.

10. A customisable exercise mat system according to claim 1, wherein the printer comprises a mat precursor selector for selecting a mat precursor from a plurality of mat precursor types based on the mat image data.

11. A customisable exercise mat system according to claim 1, wherein the printer further comprises a roller flatbed and a vacuum for holding the mat precursor in place.

12. A customisable exercise mat system according to claim 1, wherein the printer is configured to deposit an ink base layer over regions of the mat precursor surface designated to be printed on by surface markings base based on the received mat image data, before printing the surface markings.

13. A customisable exercise mat system according to claim 1, wherein the printer is configured to heat-fuse the ink onto the mat material.

14. A customisable exercise mat system according to claim 1, wherein the printer further comprises a curing element for curing the mat once the ink has been deposited on its surface.

15. A method of producing a customisable exercise mat with surface markings customised based on individual customer selections, the method comprising:
receiving customer selections via a customer input module;
generating mat image data based on the customer's selections at an output generator, and
printing the surface markings onto a mat precursor based on the mat image data using a printer.
